(19) United States
(12) Patent Application Publication
(10) Pub. No.: US 2021/0174320 A1
(43) Pub. Date: Jun. 10, 2021

(54) SYSTEMS AND METHODS FOR RECONCILIATION OF FINANCIAL TRANSACTIONS USING AUDITABLE, DISTRIBUTED FRAMEWORKS

(71) Applicant: JPMORGAN CHASE BANK, N.A., New York, NY (US)

(72) Inventors: Jason CARLYLE, Chicago, IL (US); Poorav K. SHAH, Land O Lakes, FL (US); Prashant BAJ, Mumbai (IN); Abhijeet THAKUR, Mumbai (IN)

(21) Appl. No.: 17/091,576

(22) Filed: Nov. 6, 2020

(30) Foreign Application Priority Data
Dec. 7, 2019 (IN) 201911050614

(51) Int. Cl. G06Q 20/10; G06Q 20/40; G06Q 20/38

(52) U.S. Cl. CPC G06Q 20/102; G06Q 20/3821; G06Q 20/381; G06Q 20/405

(57) ABSTRACT

Systems and methods for reconciliation of batch of financial transactions using auditable, distributed frameworks. A method may include: receiving, from a merchant node, a batch transaction settlement summary for a batch of transactions to be settled; receiving, from an acquiring bank node, validation and qualification for each transaction; receiving, from the acquiring bank node, a settlement fee for each of the validated and qualified transactions; receiving, from the acquiring bank node, a funding amount for each of the plurality of transactions; receiving, from the acquiring bank node, a funding instruction file comprising a funding instruction for each transaction; and receiving, from a commercial bank node, a confirmation of disbursement of funding amounts to a merchant account. A reconciliation smart contract may provide real-time reconciliation for each transaction written to the distributed ledger by matching each transaction with the validation and qualification, the settlement fee, and the funding instruction.

### RELATED APPLICATIONS

This application claims priority to, and the benefit of, Indian Patent Application No. 201911050614, filed Dec. 7, 2019, the disclosure of which is hereby incorporated, by reference, in its entirety.

### BACKGROUND OF THE INVENTION

### 1. Field of the Invention

The present disclosure generally relates to systems and methods for reconciliation of batch of financial transactions using auditable, distributed frameworks.

### 2. Description of the Related Art

Within merchant's acquiring space, there are many batches of financial transactions (from numerous merchants) coining into the system for settlement and many integrations with payment-brand partners (e.g., Visa, MasterCard, etc.) to settle those transactions. The incoming batches are subdivided into smaller batches that are combined with other small batches that are associated with a specific payment brand. This ungrouping/grouping leads to difficulty in ensuring every transaction from a merchant has settled correctly with visibility into each step along the way.

### SUMMARY OF THE INVENTION

Systems and methods for reconciliation of batch of financial transactions using auditable, distributed frameworks. In one embodiment, in a distributed ledger network comprising a plurality of nodes, a method for reconciliation of batch of financial transactions using auditable, distributed frameworks may include: (1) receiving, from a merchant node for a merchant in the distributed ledger network, a batch transaction settlement summary for a batch of a plurality of transactions to be settled; (2) receiving, from an acquiring bank node for an acquiring bank in the distributed ledger network, validation and qualification for each transaction of the plurality of transactions; (3) receiving, from the acquiring bank node, a settlement fee for each of the validated and qualified transactions; (4) receiving, from the acquiring bank node, a funding amount for each of the plurality of transactions based on the transaction amount and the settlement fee; (5) receiving, from the acquiring bank node, a funding instruction file comprising a funding instruction for each transaction in the batch of transactions based on the funding amounts; and (6) receiving, from a commercial bank node for a commercial bank in the distributed ledger network, a confirmation of disbursement of funding amounts to a merchant account in response to the funding instruction file. A reconciliation smart contract may provide real-time reconciliation for each transaction written to the distributed ledger by matching each transaction with the validation and qualification, the settlement fee, and the funding instruction.

In one embodiment, each of the plurality of transactions may include a transaction identifier, a payee identifier, a merchant identifier, and a transaction amount.

In one embodiment, the batch of the plurality of transactions may include transactions received within a period of time.

In one embodiment, the batch of the plurality of transactions may include a certain number of transactions.

In one embodiment, the method may further include receiving, from the acquiring bank node, an identification of one of the plurality of transaction as a cross-currency transaction; and a smart contract applying an exchange rate to the cross-currency transaction.

In one embodiment, the settlement fees may be based on the plurality of transactions in the batch.

In one embodiment, the funding amounts may be based on a funding cut-off time.

In one embodiment, the funding instruction file may include a plurality of instructions for money movement.

In one embodiment, the reconciliation smart contract may generate an alert or an event in response to a reconciliation error.

According to another embodiment, a system for reconciliation of batch of financial transactions using auditable, distributed frameworks may include a distributed ledger network a merchant node for a merchant, an acquiring bank node for an acquiring bank, and a commercial bank node for a commercial bank. Each of the merchant node, the acquiring bank node, and the commercial bank node may maintain a copy of a distributed ledger. The merchant may write a batch transaction settlement summary for a batch of a plurality of transactions to be settled to the distributed ledger via the merchant node. The acquiring bank may write validation and qualification for each transaction of the plurality of transactions to the distributed ledger via the acquiring bank node. The acquiring bank may write a settlement fee for each of the validated and qualified transactions to the distributed ledger via the acquiring bank node. The acquiring bank may write a funding amount for each of the plurality of transactions based on the transaction amount and the settlement fee to the distributed ledger via the acquiring bank node. The acquiring bank may write a funding instruction file comprising a funding instruction for each transaction in the batch of transactions based on the funding amounts to the distributed ledger via the acquiring bank node. The commercial bank may write a confirmation of disbursement of funding amounts to a merchant account in response to the funding instruction file to the distributed ledger via the commercial bank node. A reconciliation smart contract may provide real-time reconciliation for each transaction written to the distributed ledger by matching each transaction with the validation and qualification, the settlement fee, and the funding instruction.

In one embodiment, each of the plurality of transactions may include a transaction identifier, a payee identifier, a merchant identifier, and a transaction amount.

In one embodiment, the batch of the plurality of transactions may include transactions received within a period of time.

In one embodiment, the batch of the plurality of transactions may include a certain number of transactions.

In one embodiment, the acquiring bank may write an identification of one of the plurality of transaction as a cross-currency transaction via the acquiring bank node, and the smart contract may apply an exchange rate to the cross-currency transaction.

In one embodiment, the settlement fees may be based on the plurality of transactions in the batch.

In one embodiment, the funding amounts may be based on a funding cut-off time.

In one embodiment, the funding instruction file may include a plurality of instructions for money movement.

In one embodiment, the reconciliation smart contract may generate an alert or an event in response to a reconciliation error.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for reconciliation of batch of financial transactions using auditable, distributed frameworks according to one embodiment;

FIG. 2 depicts a method for reconciliation of batch of financial transactions using auditable, distributed frameworks according to one embodiment.

### DETAILED DESCRIPTION OF PREFERRED EMBODIMENTS

Embodiments are directed to systems and methods for reconciliation of batch of financial transactions using auditable, distributed frameworks.

Embodiments may use any suitable distributed ledger technology, such as Ethereum, Blockchain, Quorum, Hyperledger Fabric, Hyperledger Sawtooth, etc. to provide a continuously synchronizing database of transactions that is immutable, secured, and tamper proof. In one embodiment, distributed ledger-enabled point of sale (POS) devices and online submission systems may be used. For example, any system that may initiate a batch or settlement may be integrated into the distributed ledger network. Once the batch has been successfully sent to the acquiring bank, the same POS or system may send the summary of the batch to a configured network. This may be accomplished using, for example, an embedded piece of software that securely connects to the distributed ledger network

In one embodiment, the distributed ledger may provide smart contract functionality.

In one embodiment, the transaction data may include, for example, a merchant identification (e.g., a merchant identifier number), a batch identifier or batch file name, a submission timestamp, a count of transactions in the submission, a checksum value for all transactions (e.g., regardless of currency), an initial status, etc.

In one embodiment, a distributed ledger network may include one or more merchant(s), a payment gateway, an acquiring bank, one or more foreign exchange providers, settlement agents, treasury and commercial banks, etc. In one embodiment, the distributed network may be a permissioned, private network that may be based on mutual agreements among participating parties.

In one embodiment, the transactions in the settlement batch or submission may be processed based on certain criteria. For example, a contract between an acquiring bank and a merchant, which may be the merchant's view on the classification of the transaction for its operational and accounting purposes, may be used.

In one embodiment, a virtual account may map to a set of transaction attributes (e.g., currency pair, network, business unit, etc.). The merchant acquiring bank may classify the transactions per the configured virtual and rules associated with that virtual account, and may post fees, other debits, etc. to a virtual account. In one embodiment, a similar virtual account structure may be created in treasury services for a financial institution.

In one embodiment, a virtual account may be associated with, or tied to, a merchant Direct Deposit Account (DDA) account, collections, account, etc.

Virtual accounts may be implemented in the distributed ledger based on the underlying technology. For example, with Ethereum or Quorum, the virtual account may be an address in the network. In one embodiment, an Ethereum Wallet may be used for the purpose. Any other suitable ways, such as like implementing data structures at a smart contract layer, may be used.

In one embodiment, smart contracts may be used. Examples of smart contracts include some or all of the following:

Merchant Services Settlement Smart Contracts: these may be used to place and retrieve the transaction data in the overall process. A Smart Contract may hold business logic to record the transactions on the distributed leger, including posting of initial submission summary, apportionment of the transaction summaries into respective virtual account, applying the foreign exchange (FX) rates for a cross-currency transaction, applying the fees and other adjustments (debit or credit) on the respective virtual account, attaching the funding confirmation and necessary reference numbers on the virtual account, determining the finality of the specific batch settlement, etc. This contract may generate and listen to events, and external world and other contracts consume the events. For example, when the classifications are done into the virtual account, a FX trade may be automatically initiated. And when FX rate is loaded into the virtual account, the payable amount may be determined into the currency of settlement.

In one embodiment, FX smart contracts may hold supplemental information, and may facilitate currency conversion.

In one embodiment, funding smart contracts may facilitate fund movement.

In one embodiment, a distributed computer program or application (“DAPP”) may address the front end and/or reporting needs for each participant. In one embodiment, this may be an application in any compatible programming language that connects to the distributed ledger network, sends transactions, accesses smart contract functions, listens to events on the distributed ledger, and translates data for use. In one embodiment, the DAPP may work on a node, or a cluster of nodes, on the distributed network.

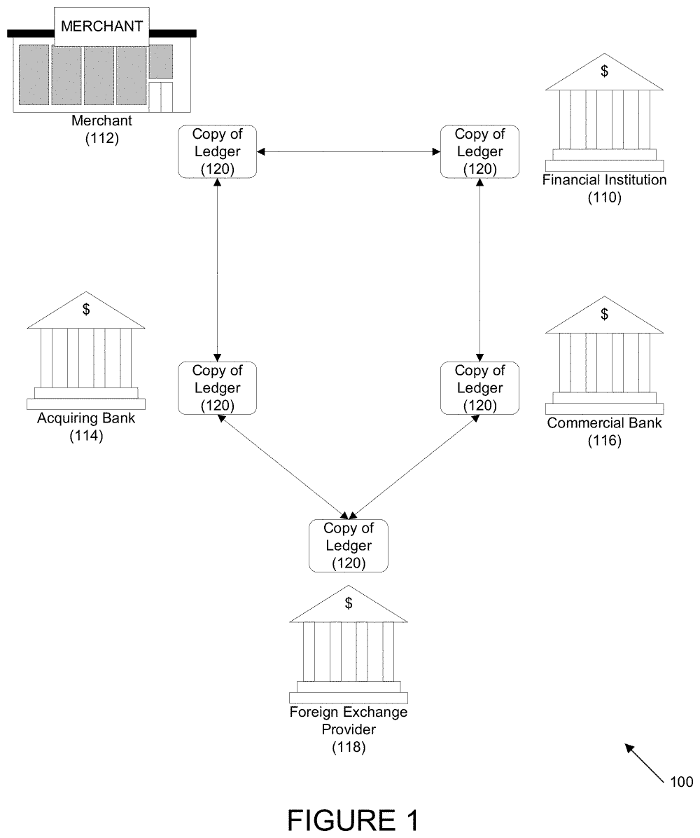

Referring to FIG. 1, a system for auditable, distributed frameworks for reconciliation of batch of financial transactions is provided according to one embodiment. System 100 may include financial institution 110, one or more merchant 112, acquiring bank 114, commercial bank 116, foreign exchange provider 118, etc. It should be noted that these entities are exemplary only; additional, fewer, and/or different entities may be provided as is necessary and/or desired.

In one embodiment, financial institution 110, one or more merchant 112, acquiring bank 114, commercial bank 116, foreign exchange provider 118, etc. may be part of a distributed ledger network, such as a private (e.g., permissioned) network. In one embodiment, the distributed ledger network may use Ethereum, quorum, Hyperledger Fabric, Hyperledger Sawtooth or any other similar technology that may function with smart contracts. The network governance is based on the mutual agreements within the participating parties.

In one embodiment, merchant(s) 112 may be provided with distributed-ledger enabled point of sale devices and/or online submission systems (not shown). These devices may initiate a batch or settlement and may be integrated to the distributed ledger network. Once the batch has been successfully sent to acquiring bank 114, the same POS or system may send the summary of the batch to the distributed ledger network. The transaction data typically includes merchant identifier number, batch id or batch file name, timestamp of submission, total count of transactions in the submission, total checksum of value of all transaction (irrespective of currency) and the initial status.

In one embodiment, each entity in the distributed ledger network may serve as a node in the distributed ledger network. In one embodiment, one or more entity may not participate as a node in the distributed ledger network but may instead access the distributed ledger network using, for example, APIs.

In one embodiment, each node in the distributed ledger network may maintain a copy of distributed ledger 120. Each node may execute one or more smart contract (not shown) that may execute upon certain conditions being met.

In addition, each node may execute a distributed app, or “DAPP” (not shown) that may server the front end/reporting needs for each participant in the distributed network. In one embodiment, the DAPP may be an application connects the node to the distributed ledger network, sends transactions, accesses smart contract functions, listens to events, and translates data for respective use.

In one embodiment, each node 120 in the distributed ledger network may execute a smart contract, such as code with business logic. The smart contract may process a distributed ledger transaction and publish the result as an event on the distributed ledger. The events may be consumed by any participant (e.g., financial institution 110, merchant 112, acquiring bank 114, commercial bank 116, foreign exchange provider 118, etc.) if it is interested in the event and permitted to use it.

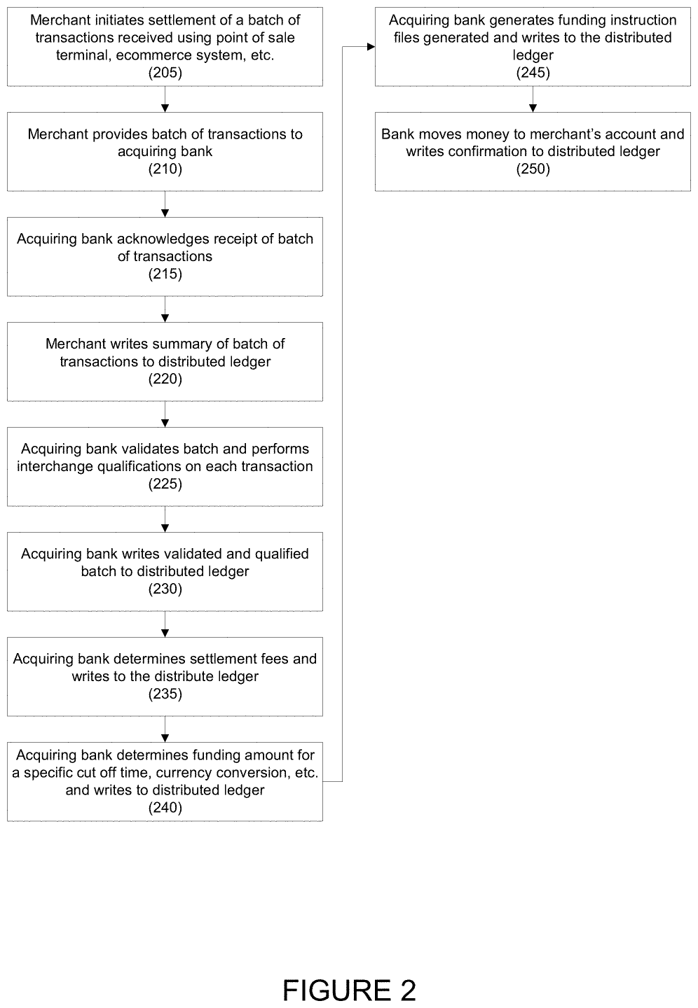

Referring to FIG. 2, a method for auditable, distributed frameworks for reconciliation of batch of financial transactions is provided according to one embodiment.

In step 205, a merchant may initiate settlement of a batch of transactions using, for example, a point of sale terminal. In one embodiment, each transaction in the batch may include an identifier, an identification of the payee (e.g., the buyer), an identification of the merchant, an amount, a currency, etc. In one embodiment, the batch may include transactions received within a certain period of time (e.g., hourly, daily, weekly, monthly, etc.), based on a number of items, combinations thereof, etc.

In step 210, the merchant may provide the batch of transactions to an acquiring bank for processing, and in step 215, the acquiring bank may acknowledge receipt of the batch of transactions.

In step 220, the merchant may write a summary of the batch of transactions to the distributed ledger.

In step 225, the acquiring bank may validate the batch, and may perform interchange qualifications on each transaction. This may determine the type of fees applicable to a transaction. It may also determine if the transaction is a cross-currency transaction, e.g., a transaction where the sale transaction is performed using card holder currency and settlement is done in merchant's local currency.

In one embodiment, the merchant may write the summary of transactions and the acquiring bank may validate the transactions in any order, in parallel, or as necessary and/or desired.

In step 230, the acquiring bank may write the validation, fees, whether the transaction is a cross-currency transaction, etc. to the distributed ledger.

In step 235, the batch may be settled. In one embodiment, the settlement may be in response to a distributed ledger event (e.g., writing of the validation, fees, etc. to the distributed ledger). In one embodiment, the acquiring bank may execute the settlement, and the result of the settlement may be written to the distributed ledger. A smart contract may interpret the transaction and may execute the reconciliation.

Based on the agreements, a merchant's transactions may be gross settled, or net settled. With gross settlement, the fees are invoiced and debited to merchant later. With net settlement, fees are calculated and deducted upfront in every settlement cycle. In embodiments, fees may be calculated based the qualification rules.

In one embodiment, the settlement fees may be written to the distributed ledger.

In one embodiment, each transaction may be associated with certain card type, such as gift card, travel card, etc., as well as other parameters, such as a contract with merchant. Those parameters may provide the basis by which transactions are qualified for certain fees and rates.

In step 240, funding amounts may be determined for a specific cut-off time, and any required currency conversions may be performed. In one embodiment, the settlement may be in response to a distributed ledger event (e.g., writing of the settlement fees to the distributed ledger).

In one embodiment, the acquiring bank may determine the net funding amounts.

In one embodiment, the FX rates used may be provided by the FX providers, like a commercial bank or payment networks such as VISA and MasterCard. Those trades may be settled separately.

In one embodiment, a FX smart contract may retrieve the foreign exchange rate applicable to the cross-currency settlement.

In another embodiment, large merchants may enter into tri-party agreements to ensure the most competitive FX rates. In those cases, the rates files are provided both to merchant acquiring bank and merchant for settlement purposes.

In one embodiment, the funding amounts, FX rate, etc. may be written to the distributed ledger.

In step 245, the acquiring bank may generate a funding instruction file and may provide the funding instruction file directly to a treasury bank or, in another embodiment, the acquiring bank may generate the funding instruction file and write it the funding instruction file to the distributed ledger. In one embodiment, the posting of a funding instruction on a distributed ledger by acquiring bank may be treated as a funding instruction for actual money movement. The funding instruction file may include relevant details for end-to-end tracking and reconciliation.

In one embodiment, the generation of the funding instructions may be in response to a distributed ledger event (e.g., writing of the funding amount to the distributed ledger).

In step 250, based on the funding instruction(s) written to the distributed ledger, a commercial bank may disburse the funds to the merchant's account and may write the disbursement to the distributed ledger. The acquiring bank, merchant and banks may then reconcile the business, fees, other adjustments (e.g., chargebacks, FX, etc.).

Throughout the process, smart contracts executed by each node may monitor the distributed ledger postings and may provide real-time reconciliation. For example, for each posting, the smart contact(s) may identify each distributed ledger transaction and match each distributed ledger transaction with, for example, the validation and qualification, settlement fees, funding amount, currency conversion, funding instruction, and money movement at a distributed ledger transaction level. In one embodiment, if there is an error, the smart contract may attempt to resolve the error, may generate an alert, notification, or event, or it may take any action as is necessary and/or desired.

It should be recognized that the embodiments disclosed herein are not exclusive to each other; features and elements from one embodiment may be used with others as is necessary and/or desired.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for reconciliation of batch of financial transactions using auditable, distributed frameworks, comprising:
in a distributed ledger network comprising a plurality of nodes:
receiving, from a merchant node for a merchant in the distributed ledger network, a batch transaction settlement summary for a batch of a plurality of transactions to be settled;
receiving, from an acquiring bank node for an acquiring bank in the distributed ledger network, validation and qualification for each transaction of the plurality of transactions;
receiving, from the acquiring bank node, a settlement fee for each of the validated and qualified transactions;
receiving, from the acquiring bank node, a funding amount for each of the plurality of transactions based on the transaction amount and the settlement fee;
receiving, from the acquiring bank node, a funding instruction file comprising a funding instruction for each transaction in the batch of transactions based on the funding amounts; and
receiving, from a commercial bank node for a commercial bank in the distributed ledger network, a confirmation of disbursement of funding amounts to a merchant account in response to the funding instruction file;
wherein a reconciliation smart contract provides real-time reconciliation for each transaction written to the distributed ledger by matching each transaction with the validation and qualification, the settlement fee, and the funding instruction.

2. The method of claim 1, wherein each of the plurality of transactions comprises a transaction identifier, a payee identifier, a merchant identifier, and a transaction amount.

3. The method of claim 1, wherein the batch of the plurality of transactions comprises transactions received within a period of time.

4. The method of claim 1, wherein the batch of the plurality of transactions comprises a certain number of transactions.

5. The method of claim 1, further comprising:
receiving, from the acquiring bank node, an identification of one of the plurality of transaction as a cross-currency transaction; and
a smart contract applying an exchange rate to the cross-currency transaction.

6. The method of claim 1, wherein the settlement fees are based on the plurality of transactions in the batch.

7. The method of claim 1, wherein the funding amounts are based on a funding cut-off time.

8. The method of claim 1, wherein the funding instruction file comprises a plurality of instructions for money movement.

9. The method of claim 1, wherein the reconciliation smart contract generates an alert or an event in response to a reconciliation error.

10. A system for reconciliation of batch of financial transactions using auditable, distributed frameworks, comprising:
a distributed ledger network comprising:
a merchant node for a merchant;
an acquiring bank node for an acquiring bank; and
a commercial bank node for a commercial bank;
wherein each of the merchant node, the acquiring bank node, and the commercial bank node maintains a copy of a distributed ledger;
wherein:
the merchant writes a batch transaction settlement summary for a batch of a plurality of transactions to be settled to the distributed ledger via the merchant node;
the acquiring bank writes validation and qualification for each transaction of the plurality of transactions to the distributed ledger via the acquiring bank node;
the acquiring bank writes a settlement fee for each of the validated and qualified transactions to the distributed ledger via the acquiring bank node;
the acquiring bank writes a funding amount for each of the plurality of transactions based on the transaction amount and the settlement fee to the distributed ledger via the acquiring bank node;
the acquiring bank writes a funding instruction file comprising a funding instruction for each transaction in the batch of transactions based on the funding amounts to the distributed ledger via the acquiring bank node; and
the commercial bank writes a confirmation of disbursement of funding amounts to a merchant account in response to the funding instruction file to the distributed ledger via the commercial bank node;
wherein a reconciliation smart contract provides real-time reconciliation for each transaction written to the distributed ledger by matching each transaction with the validation and qualification, the settlement fee, and the funding instruction.

11. The system of claim 10, wherein each of the plurality of transactions comprises a transaction identifier, a payee identifier, a merchant identifier, and a transaction amount.

12. The system of claim 10, wherein the batch of the plurality of transactions comprises transactions received within a period of time.

13. The system of claim 10, wherein the batch of the plurality of transactions comprises a certain number of transactions.

14. The system of claim 10, wherein:
the acquiring bank writes an identification of one of the plurality of transaction as a cross-currency transaction via the acquiring bank node; and
the smart contract applies an exchange rate to the cross-currency transaction.

15. The system of claim 10, wherein the settlement fees are based on the plurality of transactions in the batch.

16. The system of claim 10, wherein the funding amounts are based on a funding cut-off time.

17. The system of claim 10, wherein the funding instruction file comprises a plurality of instructions for money movement.

18. The system of claim 10, wherein the reconciliation smart contract generates an alert or an event in response to a reconciliation error.
